(19) United States
(12) Patent Application Publication
(10) Pub. No.: US 2010/0302671 A1
(43) Pub. Date: Dec. 2, 2010

(54) MAGNETIC RECORDING DEVICE, HEAD EVALUATION DEVICE, AND WRITE-POLE-ERASING EVALUATION METHOD

(75) Inventors: Hiroaki Ueno, Tokyo (JP); Masahiro Takagi, Kawasaki-shi (JP); Takahisa Ueno, Fuchu-shi (JP); Hiroshi Isokawa, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/788,185

(22) Filed: May 26, 2010

(30) Foreign Application Priority Data
May 26, 2009 (JP) 2009-126956

(51) Int. Cl. G11B 5/02

(52) U.S. Cl. 360/55; G9B/5.026

(57) ABSTRACT

According to one embodiment, a magnetic recording device includes a write controller to control such that writing first information having a same polarity throughout the first information in a predetermined region including a plurality of tracks in a recording medium, writing second information in a target track located within or close to the predetermined region, and writing third information having, at an end of the writing, a polarity opposite to the polarity of the first information in a region of the target track in which the second information is not written, are performed; a read controller to control such that the second information is read after each of writing of the second information and writing of the third information; and a determiner to determine occurrence of pole erasing based on each second information read under the control by the read controller.

### CROSS-REFERENCE TO RELATED APPLICATIONS

This application is based upon and claims the benefit of priority from Japanese Patent Application No. 2009-126956, filed May 26, 2009, the entire contents of which are incorporated herein by reference.

### BACKGROUND

1. Field

One embodiment of the invention relates to a magnetic recording device, a head evaluation device, a spin-stand device, and a write-pole-erasing evaluation method.

2. Description of the Related Art

Typically, the perpendicular magnetic recording technique is known as the recording technique for achieving high recording density in a magnetic recording device. In the perpendicular magnetic recording technique, information is recorded by perpendicularly magnetizing the magnetic layer of a recording medium facing a head.

Specifically, a magnetic recording device that records information using the perpendicular magnetic recording technique has in its recording head a main magnetic pole that performs recording and an auxiliary magnetic pole that collects a magnetic line of force. In order to record information, the main magnetic pole magnetizes the magnetic layer by generating the magnetic line of force perpendicular to the magnetic layer. The auxiliary magnetic pole then collects the magnetic line of force that has magnetized the magnetic layer.

In the perpendicular magnetic recording technique, write pole erasing phenomenon (hereinafter, “pole erasing”) occurs. Pole erasing is a phenomenon where the magnetism along the direction in which the last magnetic line of force flows upon stopping the recording current that generates the magnetic line of force remains in the magnetic head, and the recorded information on the recording medium is erased by this magnetism that has remained (residual magnetism).

Since each magnetic recording device has a different occurrence frequency of pole erasing, there is a demand for development of a test device or a test method for testing whether pole erasing is likely to occur in each magnetic recording device.

Accordingly, a test device is known that writes draft information in a track of a recording medium, overwrites a portion of the draft information written, and detects pole erasing based on a signal amplitude of the draft information immediately after the position at which the overwriting is performed (e.g., see Japanese Patent Application Publication (KOKAI) No. 2003-263702). Specifically, the test device reads a signal of the draft information before and after the overwriting and determines that pole erasing has occurred if, with respect to the pre-overwrite signal amplitude, the post-overwrite signal amplitude has decreased to a threshold value or less.

However, in the conventional art, it is not possible to test pole erasing highly accurately and highly speedily. That is, the conventional art merely expects pole erasing to incidentally occur in the write test and does not enable highly accurate testing of pole erasing.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of a magnetic recording device according to a first embodiment of the invention;

FIG. 2 is an exemplary block diagram of a configuration of a magnetic recording device according to a second embodiment of the invention;

FIGS. 3A to 3C are exemplary explanatory diagrams for explaining a write operation for a pattern A in the second embodiment;

FIGS. 4A to 4C are exemplary explanatory diagrams for explaining a write operation for a pattern B in the second embodiment;

FIGS. 5A and 5B are exemplary explanatory diagrams for explaining a write operation for a pattern C in the second embodiment;

FIGS. 6A and 6B are exemplary explanatory diagrams for explaining a determiner in the second embodiment;

FIGS. 7A to 7C are exemplary explanatory diagrams for explaining experimental results in the second embodiment;

FIG. 8 is an exemplary flowchart for explaining the sequence of operations during detection of a pole erasing performed by the magnetic recording device in the second embodiment;

FIG. 9 is an exemplary flowchart for explaining the sequence of operations during detection of the pole erasing using signal amplitudes;

FIG. 10 is an exemplary flowchart for explaining the sequence of operations during detection of the pole erasing using error rates; and

FIG. 11 is an exemplary block diagram of a configuration of a spin-stand device according to a third embodiment of the invention.

### DETAILED DESCRIPTION

Various embodiments according to the invention will be described hereinafter with reference to the accompanying drawings. In general, according to one embodiment of the invention, a magnetic recording device comprises: a write controller configured to control a first write operation of writing first information having the same polarity throughout the first information in a first predetermined region including a plurality of tracks in a recording medium, a second write operation of writing second information in a second region on a target track within or substantially close to the first predetermined region, and a third write operation of writing third information in a third region of the target track outside of the second region, the third information having, at an end of the writing, a polarity opposite to the polarity in the first write operation; a read controller configured to cause the second information to be read after the second write operation and the third write operation; and a determination module configured to determine occurrence of pole erasing based on the second information read from the recording medium.

According to another embodiment of the invention, a head evaluation device comprises: a write controller configured to control such that operations are performed, which are a first write operation of writing first information having a same polarity throughout the first information in a predetermined region including a plurality of tracks in a recording medium, a second write operation of writing second information in a target track located within or close to the predetermined region, and a third write operation of writing third information having, at an end of the writing, a polarity opposite to the polarity in the first write operation in a region of the target track in which the second write operation is not performed; a read controller configured to control such that the second information is read after each of the second write operation and the third write operation; and a determiner configured to determine occurrence of pole erasing based on each second information read under the control by the read controller.

According to yet another embodiment of the invention, a write-pole-erasing evaluation method comprises: first-writing of writing first information having a same polarity throughout the first information in a predetermined region including a plurality of tracks in a recording medium; second-writing of writing second information in a target track located within or close to the predetermined region; third-writing of writing third information having, at an end of the writing, a polarity opposite to the polarity in the first-writing in a region of the target track in which the second-writing is not performed; first-reading of reading the second information after the second-writing; second-reading of reading the second information after the third-writing; and determining of determining occurrence of pole erasing based on each of the second information read in the second-reading and the third-reading.

Various embodiments of a magnetic recording device, a head evaluation device, a spin-stand device, and a write-pole-erasing evaluation method according to the invention will be described hereinafter with reference to the accompanying drawings. In the following description, a magnetic recording device and a spin-stand device according to the invention are explained as the embodiments.

### First Embodiment

[Configuration of Magnetic Recording Device According to First Embodiment]

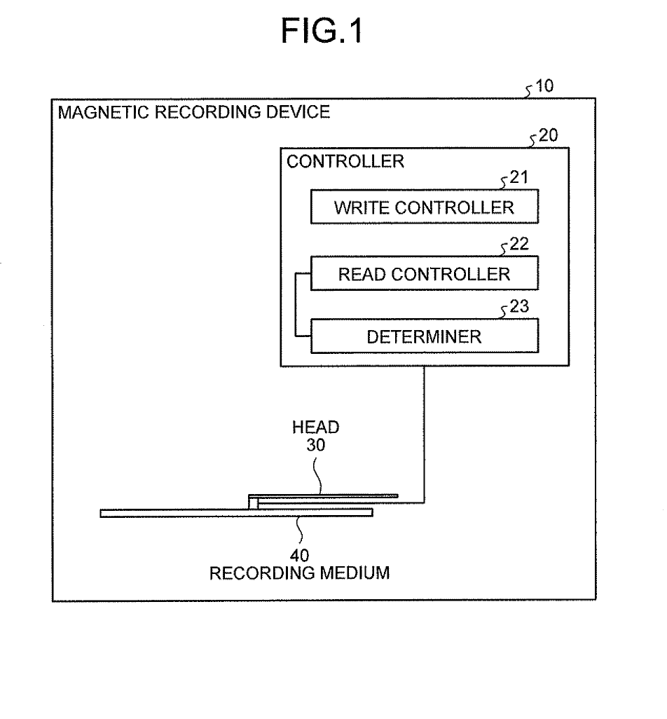

Firstly, explained below with reference to FIG. 1 is a configuration of a magnetic recording device according to a first embodiment. FIG. 1 is an exemplary block diagram of the configuration of the magnetic recording device according to the first embodiment.

As illustrated in FIG. 1, a magnetic recording device 10 according to the first embodiment comprises a controller 20, a head 30, and a recording medium 40.

The head 30 is a magnetic head embedded in the magnetic recording device 10.

The recording medium 40 is a magnetic disk embedded in the magnetic recording device 10.

The controller 20 controls the operations performed by the head 30 and comprises a write controller 21, a read controller 22, and a determiner 23 as constituent elements of particularly close association with the present embodiment.

The write controller 21 controls the head 30 for writing first information having same polarity throughout on a predetermined region including a plurality of tracks in the recording medium 40. The write controller 21 also controls the head 30 for writing second information on a target track located within or close to the abovementioned predetermined region.

Moreover, in that region of the target track which is excluded from writing the second information, the write controller 21 controls the head 30 for writing third information that at the end has the opposite polarity to the polarity of the first information.

The read controller 22 controls the head 30 for reading the second information upon completion of writing the second information under the control of the write controller 21.

In addition, the read controller 22 controls the head 30 for reading the second information upon completion of writing the third information under the control of the write controller 21.

On the basis of the second information that is read under the control of the read controller 22 upon completion of writing the second information and the second information that is read under the control of the read controller 22 upon completion of writing the third information, the determiner 23 determines whether the pole erasing has occurred.

[Effect of First Embodiment]

As described above, according to the first embodiment, the write controller 21 controls the head 30 for performing a first write operation in which the first information having same polarity throughout is written on a predetermined region including a plurality of tracks in the recording medium 40. Moreover, the write controller 21 controls the head 30 for performing a second write operation in which the second information is written on the target track located within or close to the abovementioned predetermined region. Furthermore, the write controller 21 controls the head 30 for performing a third write operation in which the third information, which at the end has the opposite polarity to the polarity of the first information, is written in that region of the target track which is excluded from writing the second information. Subsequently, the read controller 22 performs control for reading the second information not only after the second write operation but also after the third write operation. Then, based on the second information read at two different times under the control of the read controller 22, the determiner 23 determines whether the pole erasing has occurred. Thus, by writing the third information that at the end has the opposite polarity to the polarity of the first information, it becomes possible to accelerate the pole erasing and test the pole erasing with a high degree of accuracy. Besides, instead of expecting incidental occurrences of the pole erasing, it is possible to intentionally provoke the pole erasing and test the same with a high degree of accuracy.

### Second Embodiment

In a second embodiment described below, specific examples the operations performed by the controller 20 according the first embodiment are given.

[Configuration of Magnetic Recording Device According to Second Embodiment]

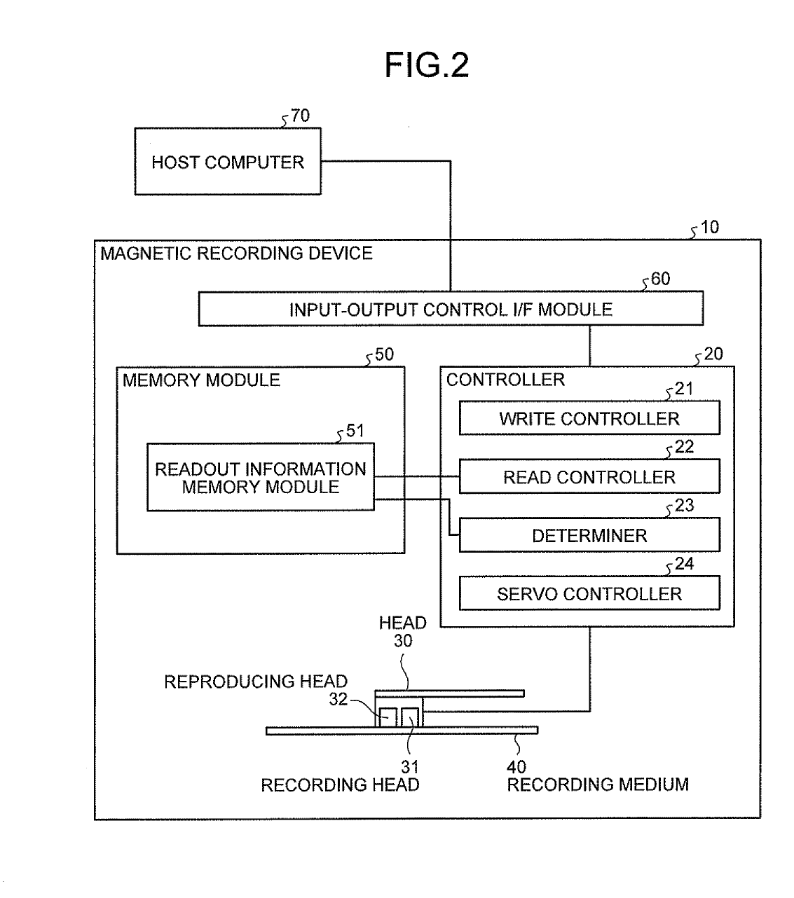

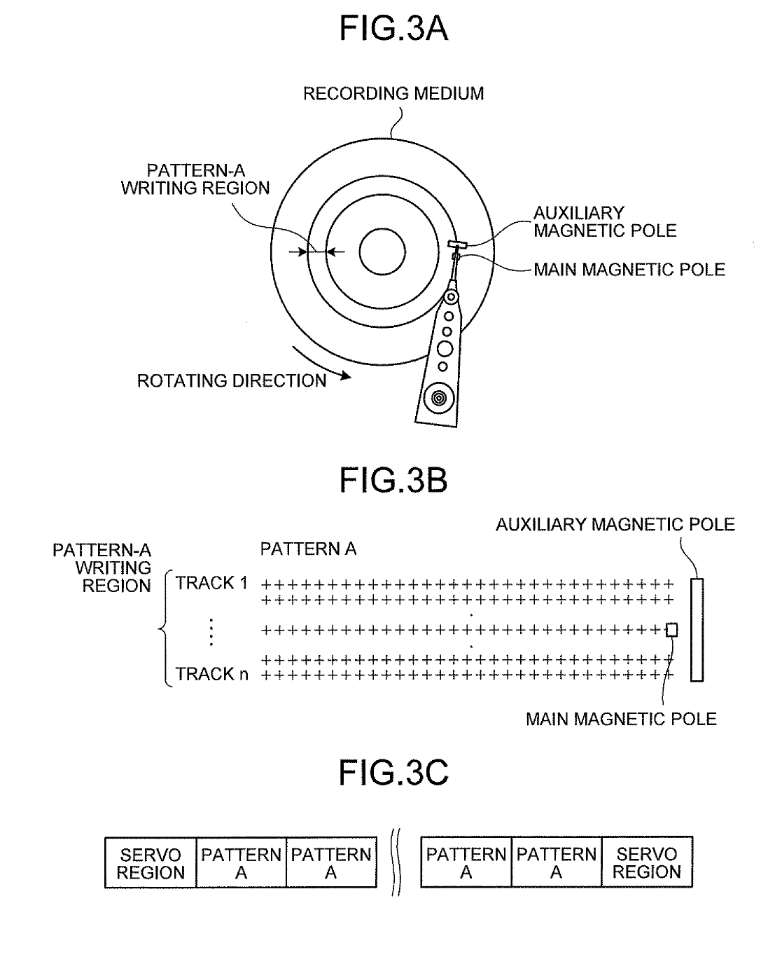

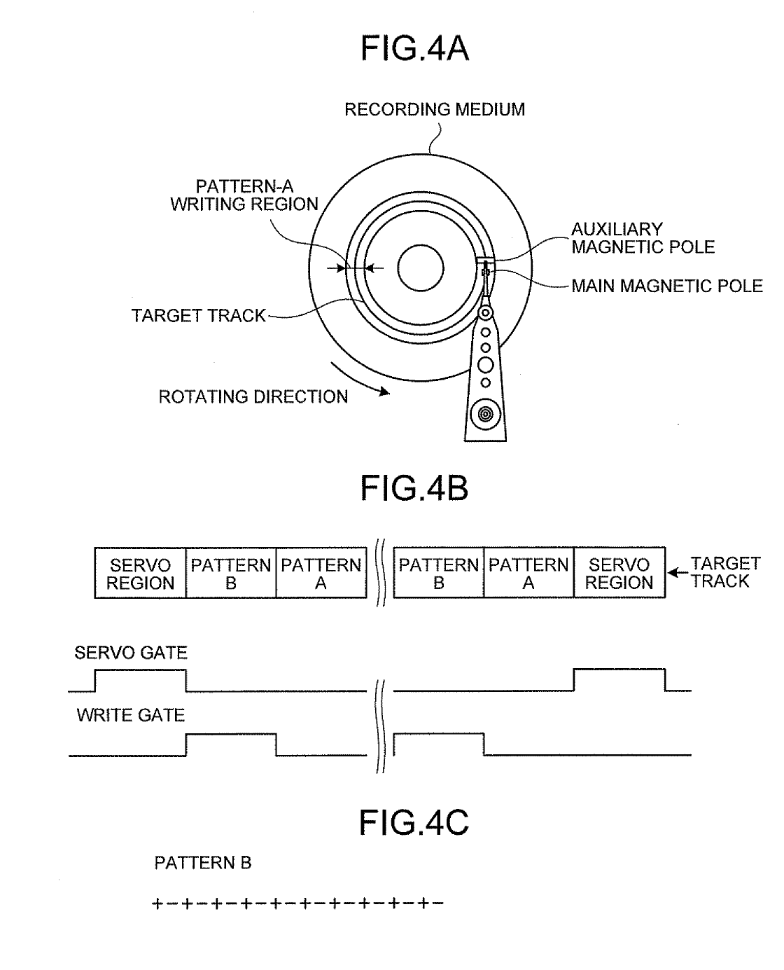

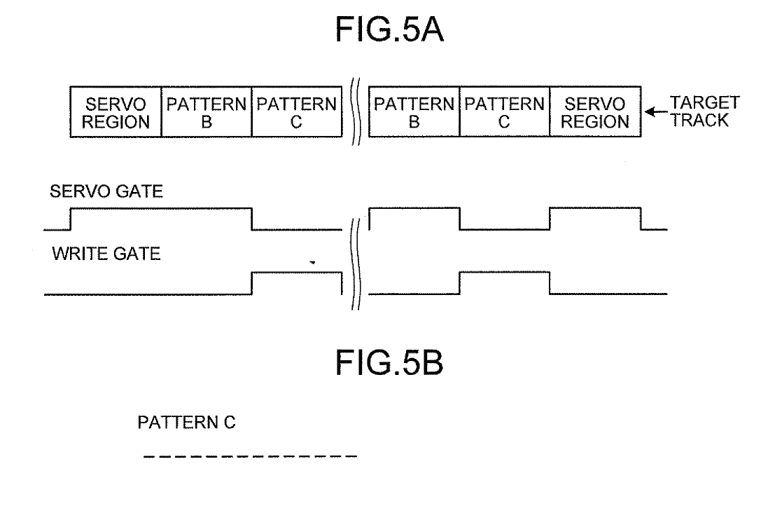

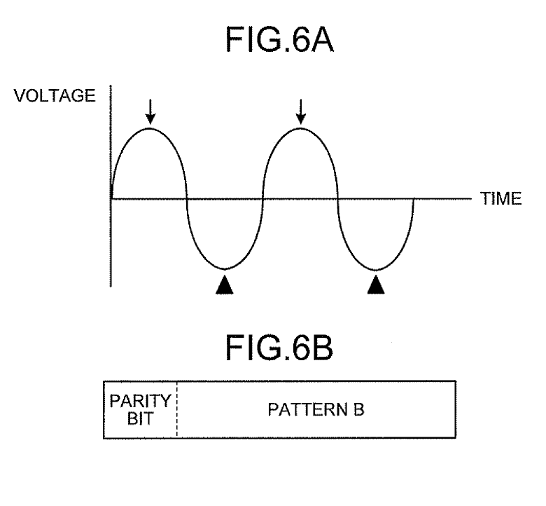

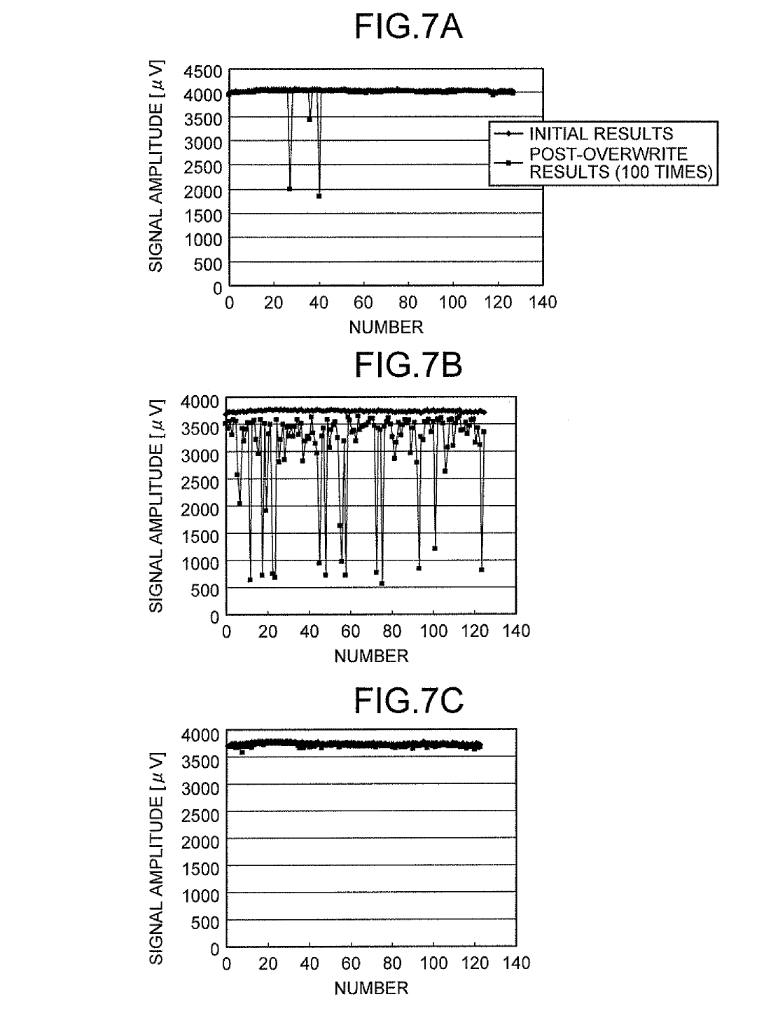

Firstly, explained below with reference to FIGS. 2 to 7 is a configuration of the magnetic recording device according to the second embodiment. FIG. 2 is an exemplary block diagram of the configuration of the magnetic recording device according to the second embodiment. FIGS. 3A to 3C are exemplary explanatory diagrams for explaining a write operation for a pattern A. FIGS. 4A to 4C are exemplary explanatory diagrams for explaining a write operation for a pattern B. FIGS. 5A and 5B are exemplary explanatory diagrams for explaining a write operation for a pattern C. FIGS. 6A and 6B are exemplary explanatory diagrams for explaining a determiner. FIGS. 7A to 7C are exemplary explanatory diagram for explaining experimental results.

As illustrated in FIG. 2, the magnetic recording device 10 according to the second embodiment comprises the controller 20, the head 30, the recording medium 40, a memory module 50, and an input-output control interface (I/F) module 60. The magnetic recording device 10 is connected to a host computer 70.

The host computer 70 is a computer device such as a personal computer (PC) that sends, to the magnetic recording device 10, a pole erasing detection command and information to be written in the recording medium 40. Meanwhile, the magnetic recording device 10 can be connected to the host computer 70 from outside or can be installed inside the host computer 70.

The input-output control I/F module 60 is an interface for communicating data between the host computer 70 and the magnetic recording device 10.

The head 30 is a magnetic head embedded in the magnetic recording device 10 and comprises a recording head 31 and a reproducing head 32.

The recording head 31 performs write operations under the control of the controller 20 described later. Although not illustrated in FIG. 2, the recording head 31 comprises a main magnetic pole that performs recording and an auxiliary magnetic pole that collects magnetic field lines emitted by the main magnetic pole.

The reproducing head 32 performs read operations under the control of the controller 20 described later.

The recording medium 40 is a magnetic disk embedded in the magnetic recording device 10.

The memory module 50 stores therein the processing results of operations performed under the control by the controller 20 described later. As a constituent element of particularly close association with the present embodiment, the memory module 50 comprises a readout information memory module 51.

The readout information memory module 51 stores therein readout information that is read under the control of the controller 20 described later. The details regarding the read information are also given later.

The controller 20 executes the pole erasing detection command received from the host computer 70 via the input-output control I/F module 60. As constituent elements of particularly close association with the present embodiment, the control module comprises the write controller 21, the read controller 22, the determiner 23, and a servo controller 24.

The servo controller 24 performs control of the head 30 based on servo information recorded by the recording medium 40 so that the head 30 gets on-track. Herein, the servo controller 24 performs control to switch ON a servo gate at a servo region in each track of the recording medium 40 and obtain servo information from the head 30.

The write controller 21 controls the head 30 for writing, as the pattern A, first information having same polarity throughout on a predetermined region including a plurality of tracks in the recording medium 40. More particularly, as illustrated in FIG. 3A, the write controller 21 instructs the main magnetic pole and the auxiliary magnetic pole of the recording head 31 for writing the pattern A on all tracks in a pattern-A writing region set in advance in the recording medium 40.

For example, as illustrated in FIG. 3B, the write controller 21 controls the head 30 for writing the pattern A by DC-erasing tracks 1 to n in the pattern-A writing region with positive polarity. Herein, on each track in the pattern-A writing region as illustrated in FIG. 3C, the write controller 21 controls the head 30 for writing the pattern A in all sectors within the region other than the servo region in which the servo information of the corresponding track is stored.

Meanwhile the pattern-A writing region can be set arbitrarily. For example, as illustrated in FIG. 3B, the pattern-A writing region is set to be a region equivalent to the width of the auxiliary magnetic pole of the recording head 31.

The write controller 21 then controls the head 30 for writing second information on a target track located within or close to the pattern-A writing region. More particularly, the write controller 21 instructs the main magnetic pole and the auxiliary magnetic pole of the recording head 31 for writing, on the target track, the pattern B that is an evaluation pattern for pole erasing test as the second information.

For example, the write controller 21 controls the head 30 for writing the pattern B on the target track within the pattern-A writing region illustrated in FIG. 4A. That is, as illustrated in FIG. 4B, the write controller 21 controls the recording head 31 for writing the pattern B in those sectors in the target track in which the pattern A is written.

Herein, as illustrated in FIG. 4B, with respect to the sectors within that region of the target track for which the servo gate is not switched ON, the write controller 21 switches ON a write gate used in write operations and then instructs the recording head 31 to write the pattern B.

The pattern B is information having polarity that periodically changes or information having polarity that aperiodically changes. For example, as the pattern B having periodic changes in polarity, the write controller 21 controls the recording head 31 for writing information having alternating change between the positive polarity and the negative polarity as illustrated in FIG. 4C.

The writing locations of the pattern B can be arbitrarily set among the sectors other than the servo region in the target track. For example, 128 locations can be set on the target track for writing the pattern B.

Subsequently, in that region of the target track in which the pattern B is not written, the write controller 21 controls the head 30 for writing, as the pattern C, third information that at the end has the opposite polarity to the polarity of the pattern A. More particularly, as illustrated in FIG. 5A, the write controller 21 controls the head 30 for writing the pattern C in those sectors in the target track in which the pattern B is not written.

For example, when the pattern A has positive polarity, the write controller 21 controls the head 30 for writing the pattern C that at least at the end has negative polarity.

Moreover, the write controller 21 controls the head 30 for writing, as the third information, information that throughout has the opposite polarity to the polarity of the first information. For example, when the pattern A has positive polarity, the write controller 21 controls the head 30 for writing the pattern C that throughout has negative polarity as illustrated in FIG. 5B.

Herein, the write controller 21 controls the writing of the pattern C in synchronization with a servo gate extending from the servo region to the pattern-B writing region. More particularly, the write controller 21 controls the writing of the pattern C on the target track when the servo gate controlled by the servo controller 24 is switched OFF.

For example, as illustrated in FIG. 5B, the servo gate is switched ON in the servo region and is extended to the pattern-B writing region. Subsequently, when the servo gate is switched OFF, the write controller 21 switches ON the write gate and controls the writing of the pattern C in those sectors in the target track in which the pattern B is not written.

Returning to the explanation with reference to FIG. 2, upon completion of writing the pattern B, the read controller 22 controls the reproducing head 32 for reading the pattern B.

Then, the read controller 22 reads readout information (initial results), which is the information read by the reproducing head 32 upon completion of the writing the pattern B, and stores that readout information in the readout information memory module 51.

Similarly, upon completion of writing the pattern C, the read controller 22 controls the reproducing head 32 for reading the pattern B.

Then, the read controller 22 reads readout information (post-overwrite results), which is the information read by the reproducing head 32 upon completion of the writing of the pattern C, and stores that readout information in the readout information memory module 51.

The determiner 23 compares the initial results and the post-overwrite results that are read by the read controller 22 and stored in the readout information memory module 51, and, if a comparison result is equal to or greater than a threshold value, determines that the pole erasing has occurred.

The following explanation is given for the cases when the pattern B is information having periodic changes in polarity and when the pattern B is information having aperiodic changes in polarity.

If the pattern B written under the control of the write controller 21 is information having polarity that periodically changes, then the determiner 23 determines occurrences of the pole erasing based on the signal amplitudes of the initial results and the post-overwrite results stored in the readout information memory module 51 and based on the threshold values for the initial results and the post-overwrite results.

More particularly, as illustrated in FIG. 6A; the determiner 23 calculates, in the signal for the initial results as well as in the signal for the post-overwrite results, the difference between the average of positive peak voltage values indicated by arrows and the average of negative peal voltage value indicated by arrowheads as the corresponding signal amplitude. If, in comparison with the signal amplitude of the initial results, the signal amplitude of the post-overwrite results decreases by a threshold value or more; then the determiner 23 determines that the pole erasing has occurred. For example, if, in comparison with the signal amplitude of the initial results, the signal amplitude of the post-overwrite results decreases by 10% or more; then the determiner 23 determines that the pole erasing has occurred.

Meanwhile, if the pattern B written under the control of the write controller 21 is information having aperiodic changes in polarity, then the determiner 23 determines occurrences of the pole erasing based on the error rates of the initial results and the post-overwrite results stored in the readout information memory module 51 and based on the threshold values for the initial results and the post-overwrite results.

More particularly, as illustrated in FIG. 6B; based on a parity bit appended in advance at the time of writing the pattern B, the determiner 23 calculates the error rate of the initial results and the error rate of the post-overwrite results. If, in comparison with the error rate of the initial results, the error rate of the post-overwrite results increases by a threshold value or more; then the determiner 23 determines that the pole erasing has occurred. For example, if, in comparison with the error rate of the initial results, the error rate of the results after the overwriting increases by 10% or more; then the determiner 23 determines that the pole erasing has occurred.

Meanwhile, calculation of the error rate is not limited to the case of using a parity bit. Alternatively, it is also possible to use a Viterbi code or an error correcting code (ECC).

Explained below are the experimental results when detection of the pole erasing was performed using the abovementioned patterns A, B, and C.

During the experiments described with reference to FIGS. 7A to 7C, detection of the pole erasing was performed with respect to the recording medium 40 in which the target track was set in the pattern-A writing region having a width of 20 μm that is substantially identical to the width of the auxiliary magnetic pole, the servo region was set at 128 locations in a single track, and the pattern-B recording region and the pattern-C recording region were sequentially set in that order immediately after each servo region. Meanwhile, in each graph in FIGS. 7A to 7C, the vertical axis represents the signal amplitude (μV) and the horizontal axis represents the numbers of the pattern B written at 128 locations.

In graph FIG. 7A is illustrated the experimental result for the case in which the pattern A was written by performing AC-erasing with random polarity, the information having periodic changes in polarity was written as the pattern B, and the polarity at the end of the pattern C was not specified. In the present experiment, the signal amplitude of the initial results was compared with the signal amplitude of the post-overwrite results obtained after writing the pattern C at respective 128 locations for 100 times and then detection of the pole erasing was performed on the basis of the comparison result. Thus, the post-overwrite results represent the pattern B after the pattern C is recorded for a total of 128×100=12800 times.

As illustrated in FIG. 7A, in comparison with the signal amplitude of the initial results, the signal amplitude of the post-overwrite results decreased at three locations thereby indicating that the pole erasing occurred at only three locations.

In FIG. 7B is illustrated the experimental result for the case in which the pattern A was written by performing DC-erasing with positive polarity, the information having periodic changes in polarity was written as the pattern B, and the pattern C was written to have the opposite polarity at the end to the polarity of the pattern A. In the present experiment, the signal amplitude of the initial results is illustrated along with the signal amplitude of the post-overwrite results obtained after writing the pattern C at respective 128 locations for 100 times. Thus, identical to FIG. 7A, the post-overwrite results represent the pattern B after the pattern C is recorded for a total of 12800 times.

As illustrated in FIG. 7B, in comparison with the signal amplitude of the initial results, the signal amplitude of the post-overwrite results decreased at almost all locations of the pattern B. Thus, as compared to FIG. 7A, the occurrences of the pole erasing are indicated with a higher degree of accuracy.

In FIG. 7C is illustrated the experimental result for the case in which the pattern A was written by performing DC-erasing with positive polarity, the information having periodic changes in polarity was written as the pattern B, and the pattern C was written to have the same polarity at the end to the polarity of the pattern A. In the present experiment, the signal amplitude of the initial results is illustrated along with the signal amplitude of the post-overwrite results obtained after writing the pattern C at respective 128 locations for 100 times. Thus, identical to FIG. 7A, the post-overwrite results represent the pattern B after the pattern C is recorded for a total of 12800 times.

As illustrated in FIG. 7C, in comparison with the signal amplitude of the initial results, the signal amplitude of the post-overwrite results does not decrease at all thereby indicating that the pole erasing has not occurred.

It is clear from the abovementioned results that, by writing the pattern A with same polarity throughout and by writing the pattern C that at the end has the opposite polarity to the polarity of the pattern A, the pole erasing can be accelerated.

Meanwhile, in the present embodiment, the pattern A is written by performing DC-erasing with positive polarity and the pattern C is written to have negative polarity at the end. However, the present embodiment is not limited to that case and it is also possible to write the pattern A by performing DC-erasing with negative polarity and to write the pattern C to have positive polarity at the end.

[Sequence of Operations Performed by Magnetic Recording Device According to Second Embodiment]

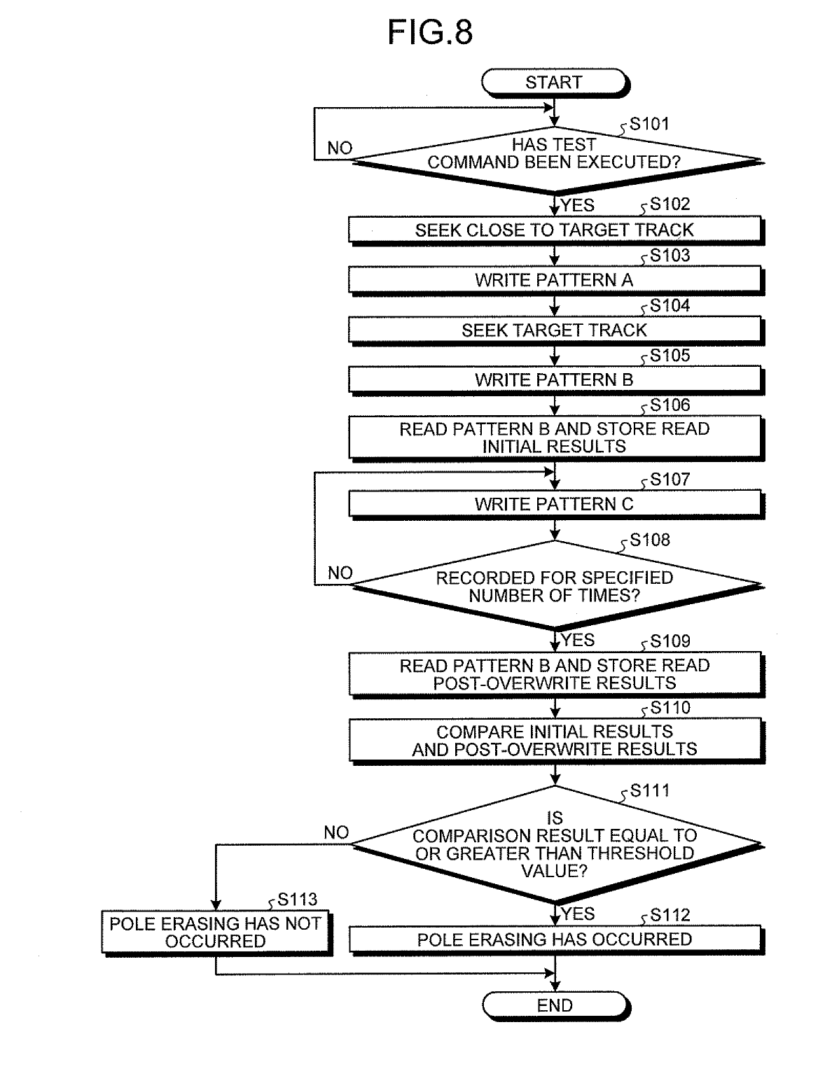

Given below is the description with reference to FIG. 8 about the operations performed by the magnetic recording device according to the second embodiment. FIG. 8 is an exemplary flowchart for explaining the sequence of operations during detection of the pole erasing performed by the magnetic recording device according to the second embodiment.

[Sequence of Operations During Detection of the Pole Erasing Performed by Magnetic Recording Device According to Second Embodiment]

As illustrated in FIG. 8, when the host computer 70 executes a test command (Yes at S101), the write controller 21 in the magnetic recording device 10 according to the second embodiment causes the head 30 to seek close to the target track (S102). Subsequently, under the control of the write controller 21, the recording head 31 writes the pattern A having same polarity throughout in all sectors in the region other than the servo region within the pattern-A writing region (S103).

The write controller 21 then causes the head 30 to seek the target track (S104). Under the control of the write controller 21, the recording head 31 writes the pattern B in all sectors in the region other than the servo region in the target track (S105). For example, the recording head 31 writes the pattern B at 128 locations in the target track.

The reproducing head 32 then reads, under the control of the read controller 22, the pattern B that has been written under the control of the write controller 21. The read controller 22 reads the initial results read by the reproducing head 32 and stores the initial results in the readout information memory module 51 (S106). For example, the reproducing head 32 reads the pattern B from each of 128 locations in the target track. The read controller 22 then reads the initial result at each of 128 locations and stores it in the readout information memory module 51.

Subsequently, under the control of the write controller 21, the recording head 31 writes the pattern C, which at the end has the opposite polarity to the polarity of the pattern A, in that region of the target track in which the pattern B is not written (S107).

Then, the write controller 21 determines whether the pattern C is written for a specified number of times (S108). More particularly, the write controller 21 instructs the recording head 31 to determine whether the pattern C is written for the same number of times for which the pattern B is written.

If the pattern C is not recorded for the specified number of times (No at S108), then the write controller 21 returns to S107 and instructs the recording head 31 to perform the writing of the pattern C.

On the other hand, if the pattern C is recorded for the specified number of times (Yes at S108), then the read controller 22 instructs the reproducing head 32 to read the pattern B, reads the post-overwrite results, and stores the post-overwrite results in the readout information memory module 51 (S109). For example, the read controller 22 instructs the reproducing head 32 to read the pattern B from 128 locations, reads the post-overwriting result at each of 128 locations, and stores the post-overwrite results in the readout information memory module 51.

Subsequently, the determiner 23 compares the initial results and the post-overwrite results stored in the readout information memory module 51 (S110) and determines whether the comparison results are equal to or greater than a threshold value (S111). More particularly, the determiner 23 compares the initial result read from each of 128 locations with the post-overwriting result read from the same location.

If any comparison results are equal to or greater than the threshold value (Yes at S111), then the determiner 23 determines that the pole erasing has occurred at respective locations (S112) and finishes detection of the pole erasing.

On the other hand, if no comparison result is equal to or greater than the threshold value (No at S111), then the determiner 23 determines that the pole erasing has not occurred (S113) and finishes detection of the pole erasing.

[Sequence of Operations During Detection of the Pole Erasing Using Signal Amplitudes]

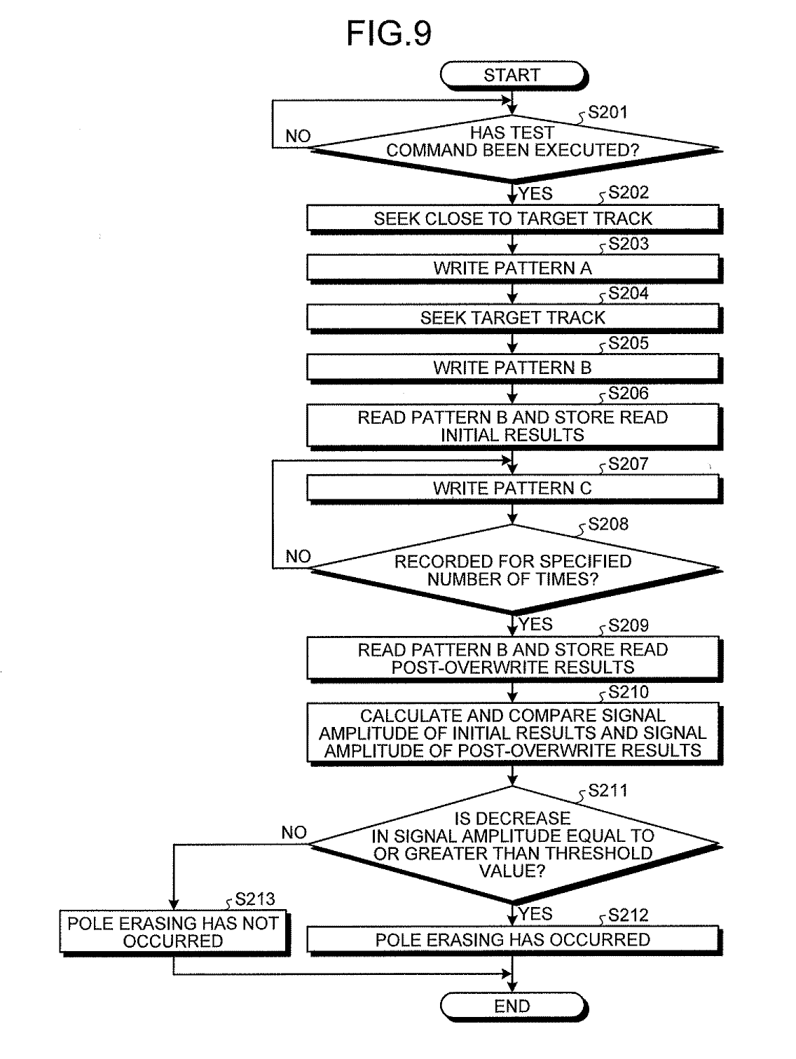

In the sequence of operations illustrated in FIG. 8, the changes in polarity of the pattern B, which is written after writing the pattern A, are not specified. However, explained below with reference to FIG. 9 is the sequence of operations during detection of the pole erasing when the pattern B having periodic changes in polarity is written. FIG. 9 is an exemplary flowchart for explaining the sequence of operations during detection of the pole erasing using the signal amplitudes.

In comparison with the sequence of operations illustrated in FIG. 8, the sequence of operations during detection of the pole erasing illustrated in FIG. 9 differs at S210 and S211.

During the writing of the pattern B at S205, if the pattern B is information having periodic changes in polarity; then the determiner 23 calculates the signal amplitude of the initial results and the signal amplitude of the post-overwrite results and compares the two calculation results (S210). Subsequently, the determiner 23 determines whether the signal amplitude decreases by a threshold value or more (S211). Herein, if, in comparison with the signal amplitude of the initial results, the signal amplitude of the post-overwrite results decreases by a threshold value or more; then the determiner 23 determines that the pole erasing has occurred (S212) and finishes detection of the pole erasing.

On the other hand, if, in comparison with the signal amplitude of the initial results, the signal amplitude of the post-overwrite results does not decrease by a threshold value or more; then the determiner 23 determines that the pole erasing has not occurred (S213) and finishes detection of the pole erasing.

[Sequence of Operations During Detection of the Pole Erasing Using Error Rates]

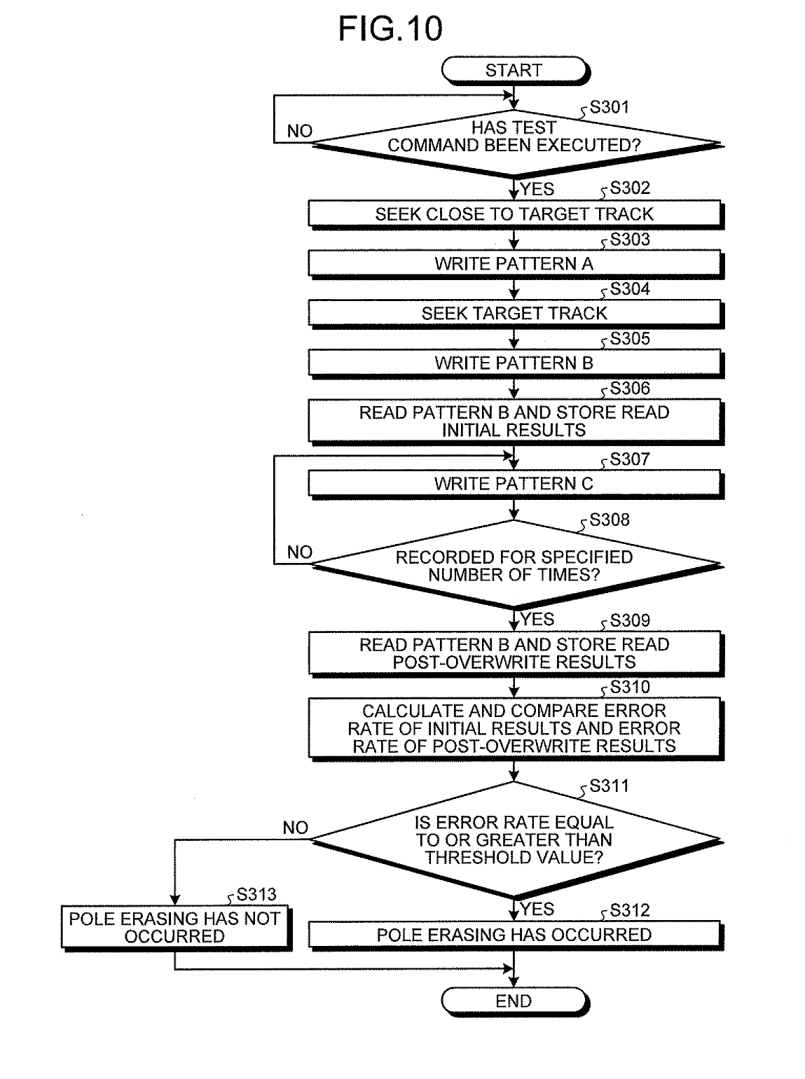

Explained below with reference to FIG. 9 is the sequence of operations during detection of the pole erasing when the pattern B having aperiodic changes in polarity is written. FIG. 10 is an exemplary flowchart for explaining the sequence of operations during detection of the pole erasing using the error rates.

In comparison with the sequence of operations illustrated in FIG. 8, the sequence of operations during detection of the pole erasing illustrated in FIG. 10 differs at S310 and S311.

During the writing of the pattern B at S305, if the pattern B is information having aperiodic changes in polarity; then the determiner 23 calculates the error rate of the initial results and the error rate of the post-overwrite results and compares the two calculation results (S310). Subsequently, the determiner 23 determines whether the error rate increases by a threshold value or more (S311). Herein, if, in comparison with the error rate of the initial results, the error rate of the post-overwrite results increases by a threshold value or more; then the determiner 23 determines that the pole erasing has occurred (S312) and finishes detection of the pole erasing.

On the other hand, if, in comparison with the error rate of the initial results, the error rate of the post-overwrite results does not increase by a threshold value or more; then the determiner 23 determines that the pole erasing has not occurred (S313) and finishes detection of the pole erasing.

[Effect of Second Embodiment]

As described above, according to the second embodiment, the write controller 21 controls the head 30 for writing the pattern A having same polarity throughout in the pattern-A writing region of the recording medium 40. The write controller 21 also controls the head 30 for writing the pattern B on the target track located within or close to the pattern-A writing region. Moreover, in that region of the target track in which the pattern B is not written, the write controller 21 controls the head 30 for writing the pattern C that at the end has the opposite polarity to the polarity of the pattern A. The read controller 22 controls the head 30 for reading the pattern B not only after the pattern B is written but also after the pattern C is written. Based on the pattern B read at two different times under the control of the read controller 22, the determiner 23 determines occurrences of the pole erasing. Thus, by writing the pattern C that at the end has the opposite polarity to the polarity of the pattern A, it becomes possible to accelerate the pole erasing and test the pole erasing with a high degree of accuracy. Besides, instead of expecting incidental occurrences of the pole erasing, it is possible to intentionally provoke the pole erasing so that it can be verified with a high degree of accuracy.

Moreover, according to the second embodiment, the write controller 21 performs control to write the pattern B in plurality and the pattern C in plurality on the target track. Then, in relation to the rotation of the recording medium 40, the read controller 22 performs control to continuously read the plurality of pattern B not only after writing of the pattern B is complete but also after writing of the pattern C is complete. Based on the reading result of continuously reading the pattern B after writing of the pattern B is complete and reading the pattern B after writing of the pattern C is complete under the control of the read controller 22, the determiner 23 determines whether the pole erasing has occurred. Thus, it becomes possible to carry out the writing test for a plurality of times around the target track and test the pole erasing with a higher speed. Moreover, by writing the pattern C in plurality on the target track, the recording current is generated again after the pole erasing has occurred but before the recording medium 40 completes a single rotation. That enables achieving reduction in the impact on the servo region.

Furthermore, according to the second embodiment, the write controller 21 performs control to write, as the pattern C, the information that throughout has the opposite polarity to the polarity of the pattern A. Because of that, the polarity at the end of the pattern C is invariably opposite to the polarity of the pattern A. That makes it possible to intentionally provoke the pole erasing in a reliable manner.

Moreover, according to the second embodiment, the write controller 21 performs control to write, as the pattern B, the information having periodic changes in polarity and the determiner 23 determines whether the pole erasing has occurred on the basis of the amplitude of the readout signal of the pattern B read under the control of the read controller 22. Thus, even when the pattern B is written by repetition of a single frequency, it becomes possible to reliably determine whether the pole erasing has occurred.

Furthermore, according to the second embodiment, the write controller 21 performs control to write, as the pattern B, the information having aperiodic changes in polarity and the determiner 23 determines whether the pole erasing has occurred on the basis of the error rate of the pattern B read under the control of the read controller 22. Thus, even when the pattern B is written in random polarities, it becomes possible to reliably determine whether the pole erasing has occurred.

Moreover, according to the second embodiment, the write controller 21 performs control to write the pattern C in synchronization with the servo gate extending from the servo region to the pattern-B writing region. For that reason, it becomes possible to set the pattern-B writing region as a non-overwritable region.

### Third Embodiment

In the second embodiment, the magnetic recording device, which is installed inside the host computer 70, detects the pole erasing occurring therein. In contrast, in a third embodiment, a spin-stand device is disposed to detect the pole erasing occurring in a magnetic recording device.

[Configuration of Spin-Stand Device According to Third Embodiment]

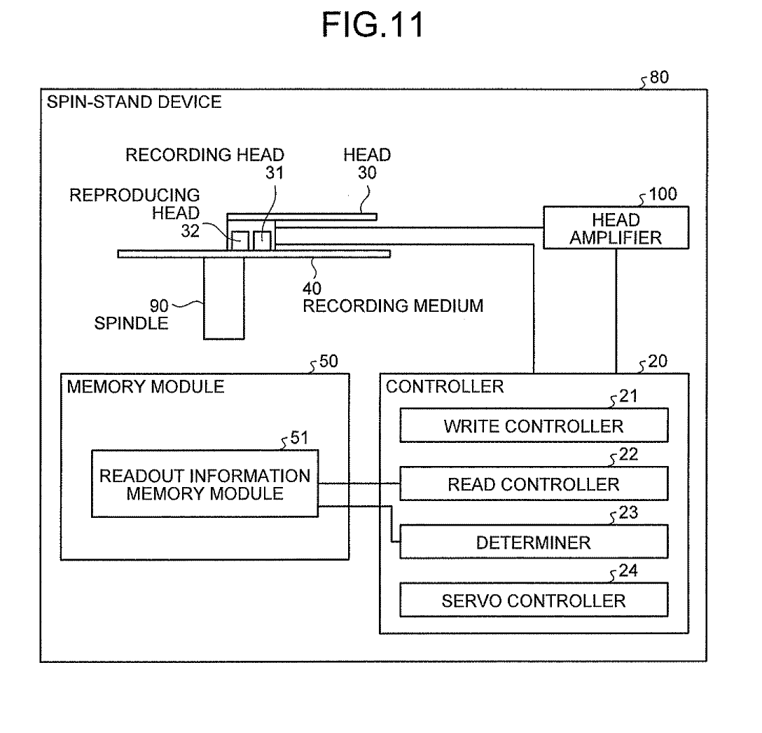

First, a configuration of a spin-stand device according to the third embodiment is described below with reference to FIG. 11. FIG. 11 is an exemplary block diagram of the configuration of the spin-stand device according to the third embodiment.

As illustrated in FIG. 11, a spin-stand device 80 according to the third embodiment comprises the controller 20, the head 30, the recording medium 40, the memory module 50, a spindle 90, and a head amplifier 100.

The spindle 90 is powered by a motor and functions as a shaft for rotating the recording medium 40.

The head amplifier 100 is an amplifying module for amplifying magnetized waveforms read from the reproducing head 32.

Herein, the operations performed by the write controller 21, the read controller 22, the determiner 23, and the servo controller 24 of the controller 20 are identical to those described in the second embodiment. Moreover, the operations performed by the recording head 31 and the reproducing head 32 of the head 30 under the control of the controller 20 as well as the contents stored in the readout information memory module 51 of the memory module 50 are also identical to those described in the second embodiment.

Thus, in an identical manner to the second embodiment, the spin-stand device 80 detects occurrences of the pole erasing by performing the write operations for writing the patterns A, B, and C and comparing the reading results of the pattern B obtained before as well as after writing the pattern C.

More particularly, the write controller 21 controls the head 30 for writing the pattern A having same polarity throughout in the pattern-A writing region in the recording medium 40. The write controller 21 also controls the head 30 for writing the pattern B on the target track located within or close to the pattern-A writing region. Moreover, in that region of the target track in which the pattern B is not written, the write controller 21 controls the head 30 for writing the pattern C that at the end has the opposite polarity to the polarity of the pattern A. The read controller 22 controls the head 30 for reading the pattern B not only after the pattern B is written but also after the pattern C is written. Based on the pattern B read at two different times under the control of the read controller 22, the determiner 23 determines occurrences of the pole erasing.

Meanwhile, since the sequence of operations during detection of the pole erasing performed by the spin-stand device 80 is identical to the sequence of operations performed by the magnetic recording device 10 described with reference to FIGS. 8 to 10, the explanation is not repeated.

[Effect of Third Embodiment]

As described above, according to the third embodiment, the spin-stand device 80 performs pole erasing test with respect to the magnetic recording device comprising the head 30, the recording medium 40, and the spindle 90. That is, it is possible to test a magnetic recording device not comprising the memory module 50 and the controller 20 for the pole erasing with a high degree of precision and at high speed.

Meanwhile, the third embodiment is not limited to the case when the spin-stand device 80 verifies a magnetic recording device for the pole erasing. Alternatively, it is also possible that a head evaluation device comprising the controller 20 and the memory module 50 verifies the head 30 for the pole erasing.

### Fourth Embodiment

Apart from the three embodiments described above, the present invention can also be implemented in various other forms that are different than the description given in the abovementioned embodiments. Thus, given below is the description from points (1) to (4) of various other embodiments.

(1) Target Track

In the abovementioned three embodiments, the target track is assumed to be located within the pattern-A writing region. Alternatively, the target track can also be located close to the pattern-A writing region.

(2) Writing Locations of Patterns B and C

In the abovementioned three embodiments, the servo region, the pattern-B writing region, and the pattern-C writing region are arranged in that order in the target track. Alternatively, the order of the pattern-B writing region and the pattern-C writing region can also be reversed. That is, the arrangement can be in the order of the servo region, the pattern-C writing region, and the pattern-B writing region.

(3) Verification Locations in Recording Medium

In the abovementioned three embodiments, the target track in the recording medium is assumed to be at a single location. Alternatively, it is also possible to set a plurality of target tracks in the same recording medium.

[System Configuration]

The processing procedures, the control procedures, specific names, various data, and information including parameters described in the embodiments or illustrated in the drawings can be changed as required unless otherwise specified. For example, occurrences of the pole erasing can be determined on the basis of a test result obtained by performing a plurality of pole erasing tests at the same location in the same recording medium.

Moreover, the constituent elements of each device illustrated in the drawings are merely conceptual, and need not be physically configured as illustrated. The processing modules or the memory modules (e.g., configuration in FIG. 2), as a whole or in part, can be separated or integrated either functionally or physically based on various types of loads or use conditions. For example, the magnetic recording device 10 can also comprise the head 30 as well as the recording medium 40 in plurality. Besides, the process functions performed by the device are entirely or partially realized by the CPU or computer programs that are analyzed and executed by the CPU, or realized as hardware by wired logic.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording device, comprising:
a write controller configured to control,
a first write operation of writing first information having the same polarity throughout the first information in a first predetermined region comprising a plurality of tracks in a recording medium,
a second write operation of writing second information in a second region on a target track within or substantially close to the first predetermined region, and
a third write operation of writing third information in a third region of the target track outside of the second region, the third information having, at an end of the writing, a polarity opposite to the polarity in the first write operation;
a read controller configured to cause the second information to be read after the second write operation and the third write operation; and
a determination module configured to determine occurrence of pole erasing based on the second information read from the recording medium.

2. The magnetic recording device of claim 1, wherein
the write controller is configured to cause a plurality of the second information and a plurality of the third information to be written in the target track,
the read controller is configured to cause the plurality of the second information to be continuously read in relation to rotation of the recording medium after the second write operation and the third write operation, and
the determination module is configured to determine the occurrence of pole erasing based on results of the plurality of the second information continuously read under the control by the read controller after the second write operation and the third write operation.

3. The magnetic recording device of claim 1, wherein the write controller is configured to cause information having a polarity opposite to the polarity of the first information throughout the information from a start to an end of the writing to be written as the third information.

4. The magnetic recording device of claim 1, wherein
the write controller is configured to cause information having a polarity that periodically changes to be written as the second information, and
the determination module is configured to determine the occurrence of pole erasing based on an amplitude of a signal of second information read under the control by the read controller.

5. The magnetic recording device of claim 4, wherein
the write controller is configured to cause information having a polarity that aperiodically changes to be written as the second information, and
the determination module is configured to determine the occurrence of pole erasing based on an error rate of second information read under the control by the read controller.

6. The magnetic recording device of claim 1, wherein the write controller is configured to cause the third information to be written in synchronization with a servo gate extending from a servo region to a region in which the second information is written.

7. A head evaluation device, comprising:
a write controller configured to control,
a first write operation of writing first information having the same polarity throughout the first information in a first predetermined region comprising a plurality of tracks in a recording medium,
a second write operation of writing second information in a second region on a target track within or substantially close to the first predetermined region, and
a third write operation of writing third information in a third region of the target track outside of the second region, the third information having, at an end of the writing, a polarity opposite to the polarity in the first write operation;
a read controller configured to cause the second information to be read after the second write operation and the third write operation; and
a determination module configured to determine occurrence of pole erasing based on the second information read from the recording medium.

8. The head evaluation device of claim 7, wherein
the write controller is configured to cause a plurality of the second information and a plurality of the third information to be written in the target track,
the read controller is configured to cause the plurality of the second information to be continuously read in relation to rotation of the recording medium after the second write operation and the third write operation, and
the determination module is configured to determine the occurrence of pole erasing based on results of the plurality of the second information continuously read under the control by the read controller after the second write operation and the third write operation.

9. The head evaluation device of claim 7, wherein the write controller is configured to cause information having a polarity opposite to the polarity of the first information throughout the information from a start to an end of the writing to be written as the third information.

10. The head evaluation device of claim 7, wherein
the write controller is configured to cause information having a polarity that periodically changes to be written as the second information, and
the determination module is configured to determine the occurrence of pole erasing based on an amplitude of a signal of second information read under the control by the read controller.

11. The head evaluation device of claim 10, wherein
the write controller is configured to cause information having a polarity that aperiodically changes to be written as the second information, and
the determination module is configured to determine the occurrence of pole erasing based on an error rate of second information read under the control by the read controller.

12. The head evaluation device of claim 7, wherein the write controller is configured to cause the third information to be written in synchronization with a servo gate extending from a servo region to a region in which the second information is written.

13. A write-pole-erasing evaluation method, comprising:
first-writing of writing first information having the same polarity throughout the first information in a first predetermined region comprising a plurality of tracks in a recording medium;
second-writing of writing second information in a second region on a target track within or substantially close to the first predetermined region;
third-writing of writing third information in a third region of the target track outside of the second region, the third information having, at an end of the writing, a polarity opposite to the polarity in the first-writing;
first-reading of reading the second information after the second-writing;
second-reading of reading the second information after the third-writing; and
determining occurrence of pole erasing based on the second information read in the second-reading and the third-reading.

14. The write-pole-erasing evaluation method of claim 13, wherein
a plurality of the second information and a plurality of the third information are written in the target track in the second-writing or in the third-writing respectively,
the plurality of the second information are read continuously in relation to rotation of the recording medium in the first-reading and the second-reading, and
the occurrence of pole erasing is determined based on results of the plurality of the second information continuously read in the first-reading and the second-reading in the determining.

15. The write-pole-erasing evaluation method of claim 13, wherein information having a polarity opposite to the polarity of the first information throughout the information from a start to an end of the writing is written as the third information in the third-writing.

16. The write-pole-erasing evaluation method of claim 13, wherein
information having a polarity that periodically changes is written as the second information in the second-writing, and
the occurrence of pole erasing is determined based on an amplitude of a signal of second information read in the first-reading and the second-reading in the determining.

17. The write-pole-erasing evaluation method of claim 16, wherein
information having a polarity that aperiodically changes is written as the second information in the second-writing, and
the occurrence of pole erasing is determined based on an error rate of second information read in the first-reading and the second-reading in the determining.

18. The write-pole-erasing evaluation method of claim 13, wherein the third information is written in synchronization with a servo gate extending from a servo region to a region in which the second information is written in the third-writing.
